(19) United States
(12) Patent Application Publication
(10) Pub. No.: US 2025/0249588 A1
(43) Pub. Date: Aug. 7, 2025

(54) REMOTE CONTROL SYSTEM, ROBOT REMOTE CONTROL METHOD, AND REMOTE CONTROL PROGRAM

(71) Applicant: KAWASAKI JUKOGYO KABUSHIKI KAISHA, Kobe-shi, Hyogo (JP)

(72) Inventors: Ayumi KISHIDA, Kobe-shi (JP); Hitoshi HASUNUMA, Kobe-shi (JP); Masayuki KAMON, Kobe-shi (JP)

(73) Assignee: KAWASAKI JUKOGYO KABUSHIKI KAISHA, Kobe-shi, Hyogo (JP)

(21) Appl. No.: 18/856,925

(22) PCT Filed: Apr. 14, 2023
(86) PCT No.: PCT/JP2023/015227

§ 371 Date: Oct. 15, 2024

(30) Foreign Application Priority Data
Apr. 15, 2022 (JP) 2022-067838

(51) Int. Cl. B25J 9/16; B25J 13/02

(52) U.S. Cl. CPC B25J 9/1689; B25J 13/025

(57) ABSTRACT

A remote control system includes a robot, an operator that receives input from a user, a display that presents an image of the robot to the user, a haptic stimulator that applies a stimulus to a user's sense of touch, and a controller that controls the robot based on the input to the operator. The controller operates the haptic stimulator if the robot contacts another object.

### FIELD

The technique disclosed here relates to a remote control system, a robot remote control method, and a remote control program.

### BACKGROUND

Conventionally, there has been known a technique of remotely controlling a robot via an operator. For example, Patent Document 1 discloses a remote control system including a robot and an operator located at positions physically apart from each other. In this remote control system, an image of the robot is displayed on a display. A user remotely operates the robot by operating the operator while viewing the display.

### CITATION LIST

### Patent Document

Patent Document 1: Japanese Unexamined Patent Application Publication No. 2010-89211

### SUMMARY OF THE INVENTION

In the above-described remote control system, the user checks the status of the robot via the display. Thus, the accuracy of checking the status of the robot by the user depends on the quality of the image displayed on the display. If the image quality is improved in order to enhance the checking accuracy, there is a probability that the image displayed on the display delays and a time lag is caused in checking the status of the robot.

The technique disclosed here has been made in view of the above-described points, and an object thereof is to properly determine the status of a robot by a user in robot remote control.

A remote control system disclosed here includes a robot, an operator that receives input from a user, a display that presents an image of the robot to the user, a haptic stimulator that applies a stimulus to a user's sense of touch, and a controller that controls the robot based on the input to the operator, and the controller operates the haptic stimulator if the robot contacts another object.

Moreover, a robot remote control system disclosed here includes a robot, an operator that receives input from a user, a display that presents an image of the robot to the user, a haptic stimulator that applies a stimulus to a user's sense of touch, and a controller that causes the robot to perform a job including steps based on the input to the operator, and the controller operates the haptic stimulator upon completion of at least one of the steps.

A robot remote control method disclosed here is a robot remote control method for controlling a robot via an operator, and the method includes receiving input from a user via the operator, moving the robot based on the input to the operator, presenting an image of the moving robot to the user via a display, and operating a haptic stimulator that applies a stimulus to a user's sense of touch if the robot contacts another object.

A remote control program disclosed here is a remote control program causing a computer to implement a function of controlling a remote control system including a robot, an operator that receives input from a user, and a haptic stimulator that applies a stimulus to a user's sense of touch, and the remote control program further causes the computer to implement a function of receiving the input from the user via the operator, a function of moving the robot based on the input to the operator, and a function of operating a haptic stimulator that applies a stimulus to a user's sense of touch if the robot contacts another object.

According to the above-described remote control system, the user can properly determine the status of the robot.

According to the above-described robot remote control method, the user can properly determine the status of the robot.

According to the above-described remote control program, the user can properly determine the status of the robot.

### BRIEF DESCRIPTION OF THE DRAWINGS

FIG. 1 is a schematic view showing the configuration of a remote control system according to an embodiment.

FIG. 2 is a schematic front view of a hand 2.

FIG. 3 is a diagram showing a schematic hardware configuration of a controller 6.

FIG. 4 is a functional block diagram of the controller 6.

FIG. 5 is a flowchart of remote control.

FIG. 6 is a flowchart of remote control according to a modification.

### DESCRIPTION OF EMBODIMENTS

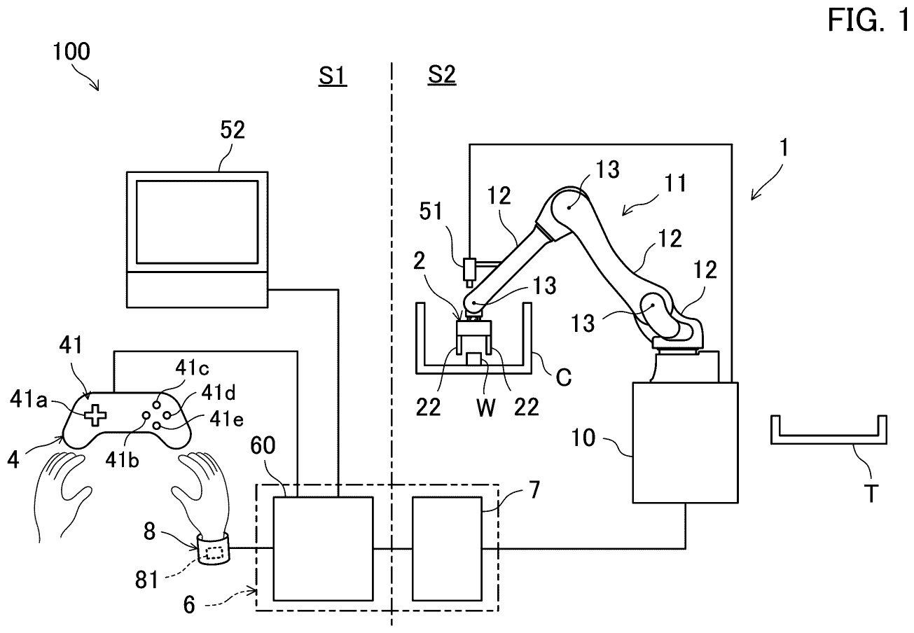

Hereinafter, an exemplary embodiment will be described in detail with reference to the drawings. FIG. 1 is a schematic view showing the configuration of a remote control system 100 according to the embodiment.

The remote control system 100 includes a robot 1, an operator 4 that receives input from a user, a display 52 that presents an image of the robot 1 to a user, a haptic stimulator 8 that applies a stimulus to a user's sense of touch, and a controller 6 that controls the robot 1 based on the input to the operator 4. The operator 4, the display 52, and the haptic stimulator 8 are located at a first site S1 at which the user is present. The robot 1 is located at a second site S2 different from the first site S1. The controller 6 implements remote control between the operator 4 and the robot 1. The operator 4 functions as a master, and the robot 1 functions as a slave.

The remote control system 100 may further include an imager 51 that captures the image of the robot 1. The imager 51 is located at the second site S2. The display 52 displays the image captured by the imager 51.

According to the remote control system 100, the user causes the robot 1 to perform a predetermined job by remotely controlling the robot 1 via the operator 4. At this time, the imager 51 captures the image of the robot 1, and the display 52 displays such a captured image. The user operates the operator 4 while checking the image of the robot 1 displayed on the display 52. In addition, the haptic stimulator 8 applies the stimulus to the user's sense of touch at arbitrary timing. The user receives the haptic stimulus from the haptic stimulator 8 so that the user can recognize occurrence of a predetermined event during the remote operation.

Note that in the present disclosure, the job performed by the robot 1 does not include a teaching job and teaching confirmation and correction jobs. Thus, the operator 4 does not include a teaching pendant.

### [Robot]

The robot 1 is an industrial robot. The robot 1 includes a robot arm 11 and a hand 2 having fingers 22 that perform opening-closing movement and coupled to the robot arm 11.

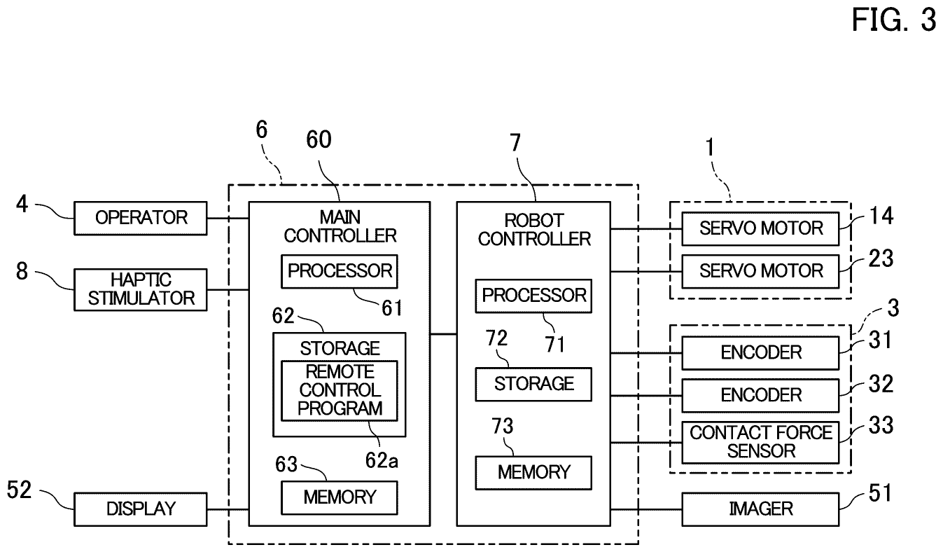

The robot arm 11 changes the position and posture of the hand 2. The robot arm 11 is a vertical articulated robot arm. The robot arm 11 has links 12, joints 13 connecting the links 12, servo motors 14 that rotationally drive the joints 13 (see FIG. 3), and encoders 31 that detect the rotation positions of the servo motors 14 (see FIG. 3). For example, the link 12 positioned at one end portion of the robot arm 11 is coupled to a base 10 via the joint 13 so as to rotate about a rotation axis extending in the vertical direction. Note that the robot arm 11 may be of a horizontal articulated type, a parallel link type, a Cartesian coordinate type, a polar coordinate type, or the like.

The hand 2 is an end effector of the robot arm 11. The hand 2 is coupled to the tip end of the robot arm 11. Specifically, the hand 2 is coupled to the link 12 at the end portion opposite to the link 12 coupled to the base 10 among the links 12. The hand 2 can be in various postures by movement of the robot arm 11.

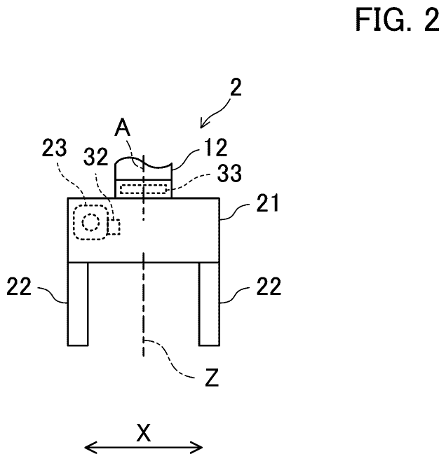

FIG. 2 is a schematic front view of the hand 2. The hand 2 has a hand body 21 and two fingers 22 disposed at the hand body 21. The hand body 21 is coupled to the link 12 of the robot arm 11 so as to rotate about a predetermined rotation axis A. The two fingers 22 are aligned in a predetermined opening-closing direction X. Specifically, the two fingers 22 are located symmetrically with respect to a center axis Z substantially perpendicular to the opening-closing direction X. The center axis Z is substantially linearly aligned with the rotation axis A. The two fingers 22 perform the opening-closing movement in the opening-closing direction X. The finger 22 extends in a direction crossing the opening-closing direction X. Specifically, the finger 22 extends substantially parallel with the center axis Z. The hand 2 further has a servo motor 23 that causes the two fingers 22 to perform the opening-closing movement, and an encoder 32 that detects the rotation position of the servo motor 23.

The remote control system 100 further includes a sensor 3 that detects a force acting on the robot 1. The sensor 3 includes a contact force sensor 33 that detects a force acting on the fingers 22 from a surface on which a workpiece W is placed. As shown in FIG. 2, the contact force sensor 33 is disposed at the hand 2. Specifically, the contact force sensor 33 is disposed at a portion of the hand 2 coupled to the robot arm 11. The contact force sensor 33 detects a force at least in the direction of the center axis Z between the two fingers 22, i.e., a force in the direction of the rotation axis A of the hand 2 against the link 12. Specifically, the contact force sensor 33 detects forces in orthogonal triaxial directions including the direction of the center axis Z between the fingers 22 and moments about these triaxial directions. When gripping the workpiece W, the hand 2 normally moves in the direction of the center axis Z, and contacts the surface on which the workpiece W is placed. That is, the contact force sensor 33 detects a contact force acting on the fingers 22 from the surface on which the workpiece W is placed. Note that the contact force sensor 33 may detect only forces in uniaxial, biaxial, or triaxial directions. The contact force sensor 33 is one example of a first sensor.

The encoder 31 and the encoder 32 are included in the sensor 3. Although details will be described later, in a case where a deviation between the current rotation position of the servo motor 14 detected by the encoder 31 and the target rotation position of the servo motor 14 is great, the robot arm 11 contacts another object, i.e., an external force is acting on the robot 1. Similarly, in a case where a deviation between the current rotation position of the servo motor 23 detected by the encoder 32 and the target rotation position of the servo motor 23 is great, the fingers 22 contact another object, i.e., an external force is acting on the robot 1. That is, each of the encoder 31 and the encoder 32 also functions as a sensor that detects the force acting on the robot 1. Here, the encoder 32 is equivalent to a second sensor that detects a force acting on the fingers 22 from the workpiece W in the opening-closing direction X of the fingers 22.

### [Operator]

As shown in FIG. 1, the operator 4 has an input 41 to be operated by the user to make input. The input 41 includes a direction key 41a, a first input button 41b, a second input button 41c, a third input button 41d, and a fourth input button 41e. The operator 4 receives the input for remotely operating the robot 1, and outputs operation information which is input information to the controller 6.

Various types of operation input can be made via the operator 4 by combination of the direction key 41a, the first input button 41b, the second input button 41c, the third input button 41d, and the fourth input button 41e. For example, in a case of moving the robot arm 11, the user can make, by operating the direction key 41a, input for moving the hand 2 in a direction corresponding to the direction key 41a among the front, back, left, and right directions. At this time, the user can make, via the second input button 41c and the fourth input button 41e, input for moving the hand 2 up and down. In a case of moving the fingers 22, the user can make input for the closing movement of the fingers 22 by operating the first input button 41b, and make input for the opening movement of the fingers 22 by operating the third input button 41d. The user can also switch an option via the direction key 41a, and can make input for a predetermined command via the first input button 41b as an enter button or the third input button 41d as a cancellation button. For example, the user selects one command from command options displayed on the display 52 via the direction key 41a, and determines the command via the first input button 41b, and in this manner, can input a desired command.

### [Imager]

The imager 51 is located at the second site S2. Specifically, the imager 51 is attached to a tip end portion of the robot arm 11. The imager 51 captures the image of the robot 1, specifically an image of the hand 2. The imager 51 outputs the captured image to the controller 6.

### [Display]

The display 52 is located at a position viewable while the user is operating the operator 4. The display 52 displays the image captured by the imager 51 and transmitted from the controller 6. The display 52 assists the user who is operating the operator 4 by displaying the captured image of the robot 1.

### [Haptic Stimulator]

The haptic stimulator 8 has a voice coil motor 81, for example. The haptic stimulator 8 is attached, for example, to the wrist of the user. The haptic stimulator 8 generates vibration by operation of the voice coil motor 81. By vibration of the voice coil motor 81, the haptic stimulator 8 applies the stimulus to the user's sense of touch.

The haptic stimulator 8 can change its vibration mode. The vibration mode includes an amplitude, a frequency, a repetition period, a rhythm, and the like. For example, the haptic stimulator 8 can adjust the amplitude, i.e., the magnitude of vibration, by adjusting current applied to the voice coil motor 81. The haptic stimulator 8 can adjust the magnitude of vibration in three levels. The haptic stimulator 8 can selectively generate a first vibration as relatively-small vibration, a second vibration greater than the first vibration, and a third vibration greater than the second vibration. The first vibration, the second vibration, and the third vibration may be continuous or intermittent. The vibration modes of the first vibration, the second vibration, and the third vibration may be the same as each other or different from each other. Note that in addition to or instead of the amplitude, the haptic stimulator 8 may adjust the frequency of vibration. Further, the haptic stimulator 8 can also generate a warning vibration in addition to the first vibration, the second vibration, and the third vibration. For example, the amplitude of the warning vibration is greater than those of the first vibration, the second vibration, and the third vibration, and the vibration mode of the warning vibration is different from those of the first vibration, the second vibration, and the third vibration.

### [Controller]

The robot 1, the sensor 3, the operator 4, the imager 51, the display 52, and the haptic stimulator 8 are connected to the controller 6. The controller 6 moves the robot 1 based on the operation information from the operator 4. Specifically, the controller 6 causes the robot 1 to perform a job including steps based on the input to the operator 4. For example, the controller 6 causes the robot 1 to perform a job of picking the workpiece W. In this example, the controller 6 does not control the force and position of the operator 4 based on the state of the robot 1. The controller 6 performs so-called unilateral control of unilaterally controlling the robot 1 based on the operation information from the operator 4.

In parallel with the control of the robot 1, the controller 6 transmits the captured image from the imager 51 to the display 52. Further, the controller 6 controls the haptic stimulator 8 according to the status of the robot 1. Specifically, the controller 6 presents the status of contact of the robot 1 with another object to the user's sense of touch via the haptic stimulator 8. In this manner, the controller 6 performs the control of the robot 1, the presentation of the captured image, and the control of the haptic stimulator 8 in parallel.

FIG. 3 is a diagram showing a schematic hardware configuration of the controller 6. The controller 6 has a main controller 60 and a robot controller 7. The main controller 60 transmits and receives information, commands, data, and the like to and from the robot controller 7.

The main controller 60 receives a signal from the operator 4, and outputs a command to the robot controller 7. Based on the command, the robot controller 7 applies current to the servo motor 14 or the servo motor 23. At this time, the robot controller 7 receives a signal from the encoder 31 or the encoder 32, and performs feedback control on the servo motor 14 or the servo motor 23. Further, the robot controller 7 receives signals from the encoder 31, the encoder 32, and the contact force sensor 33 and an image signal from the imager 51, and outputs the received signals to the main controller 60. The main controller 60 outputs the image signal from the imager 51 to the display 52. The main controller 60 controls the haptic stimulator 8 based on the signals from the encoder 32 and the contact force sensor 33.

The robot controller 7 has a processor 71, a storage 72, and a memory 73. The main controller 60 has a processor 61, a storage 62, and a memory 63.

The processor 71 controls the entirety of the robot controller 7. The processor 61 controls the entirety of the main controller 60. Each of the processor 71 and the processor 61 performs various types of arithmetic processing. For example, each of the processor 71 and the processor 61 is a processor such as a central processing unit (CPU). Each of the processor 71 and the processor 61 may be a micro controller unit (MCU), a micro processor unit (MPU), a field programmable gate array (FPGA), a programmable logic controller (PLC), a system LSI, or the like.

The storage 72 stores a program to be executed by the processor 71 and various types of data. The storage 62 stores a program to be executed by the processor 61 and various types of data. Specifically, the storage 62 stores a remote control program 62a. Each of the storage 72 and the storage 62 is a non-volatile memory, a hard disc drive (HDD), a solid state drive (SSD), or the like.

Each of the memory 73 and the memory 63 temporarily stores data and the like. For example, each of the memory 73 and the memory 63 is a volatile memory.

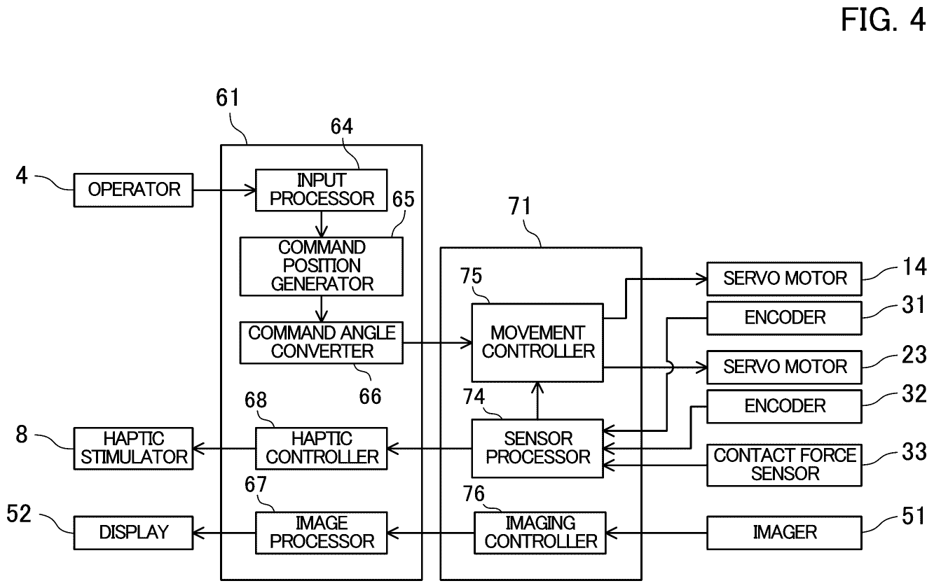

FIG. 4 is a functional block diagram of the controller 6. The processor 61 implements various functions by reading the remote control program 62a from the storage 62 and loading the remote control program 62a into the memory 63. Specifically, the processor 61 functions as an input processor 64, a command position generator 65, a command angle converter 66, an image processor 67, and a haptic controller 68. The processor 71 implements various functions by reading the program from the storage 72 and loading the program into the memory 73. Specifically, the processor 71 functions as a sensor processor 74, a movement controller 75, and an imaging controller 76.

The input processor 64 switches, based on the operation information from the operator 4, the operation between a first mode for moving the robot arm 11 and a second mode for moving the fingers 22. For example, the user operates the direction key 41a, the first input button 41b, or the second input button 41c, and accordingly, a mode switching command is input from the operator 4 to the input processor 64.

The input processor 64 generates, based on the operation information from the operator 4, a command velocity for a movement object in the current mode.

Specifically, in the case of the first mode, the user inputs the movement direction of the hand 2 by operating the direction key 41a or the like. The input processor 64 generates a command velocity for the hand 2 based on the movement direction input from the operator 4. The command velocity is a so-called velocity vector, and is defined by movement direction and speed. Here, the speed is constant. Note that by operation of the direction key 41a or the like, the speed of the hand 2 may be input in addition to the movement direction of the hand 2. In this case, the input processor 64 generates the command velocity for the hand 2 based on the movement direction and speed input from the operator 4.

In the case of the second mode, the user inputs the movement direction, i.e., the opening or closing direction, of the fingers 22 by operating the direction key 41a or the like. The input processor 64 generates a command velocity for the fingers 22 based on the movement direction input from the operator 4. The command velocity is a so-called velocity vector, and is defined by movement direction and speed. Here, the speed is constant. Note that by operation of the direction key 41a or the like, the speed of the fingers 22 may be input in addition to the movement direction of the fingers 22. In this case, the input processor 64 generates the command velocity for the fingers 22 based on the movement direction and speed input from the operator 4.

The command position generator 65 converts the command velocity generated by the input processor 64 into a command position. The command position generator 65 obtains a command position for the hand 2 in the case of the first mode, and obtains a command position for the fingers 22 in the case of the second mode. Here, the command position for the hand 2 includes not only the position of the hand 2, but also the posture of the hand 2. Note that even after the opening-closing movement of the fingers 22, the posture of the fingers 22 relative to the hand body 21 do not change, and for this reason, the command position for the fingers 22 does not include the posture of the fingers 22.

The command angle converter 66 converts the command position obtained by the command position generator 65 into a command angular position for the servo motor. The command angle converter 66 obtains, as the command angular position, the angular position of the servo motor 14 corresponding to the command position for the hand 2 in the case of the first mode. The command angle converter 66 obtains, as the command angular position, the angular position of the servo motor 23 corresponding to the command position for the fingers 22 in the case of the second mode. The command angle converter 66 outputs the obtained command angular position to the robot controller 7.

The sensor processor 74 receives detection signals, i.e., detection results, from the encoder 31, and the encoder 32, and the contact force sensor 33. The sensor processor 74 outputs the detection signals from the encoder 31 and the encoder 32 to the movement controller 75. Further, the sensor processor 74 outputs the detection signals from the encoder 31, the encoder 32, and the contact force sensor 33 to the main controller 60.

The movement controller 75 receives the command angular position from the main controller 60, and moves the robot 1 according to the command angular position. Specifically, when receiving the command angular position for the servo motor 14, the movement controller 75 obtains a current command value for the command angular position. The movement controller 75 applies current corresponding to the current command value to the servo motor 14, and accordingly, the robot arm 11 moves. At this time, the movement controller 75 performs feedback control on the current applied to the servo motor 14 based on the detection signal of the encoder 31 output from the sensor processor 74. In this manner, the hand 2 moves to the command position. Alternatively, when receiving the command angular position for the servo motor 23, the movement controller 75 obtains a current command value for the command angular position. The movement controller 75 applies current corresponding to the current command value to the servo motor 23, and accordingly, the fingers 22 move. At this time, the movement controller 75 performs feedback control on the current applied to the servo motor 23 based on the detection signal of the encoder 32 output from the sensor processor 74. In this manner, the fingers 22 move to the command position.

The imaging controller 76 causes the imager 51 to capture an image by outputting a command to the imager 51. The imaging controller 76 receives the captured image from the imager 51, and transmits the captured image to the main controller 60.

The image processor 67 transfers the captured image, i.e., the image signal, from the imager 51 to the display 52. At this time, the image processor 67 may perform predetermined image processing on the captured image.

The haptic controller 68 controls the haptic stimulator 8. Specifically, the haptic controller 68 determines whether or not the robot 1 contacts another object, and vibrates the haptic stimulator 8 if the contact occurs. The haptic controller 68 determines the occurrence of the contact based on the detection result of the sensor 3 including the encoder 31, the encoder 32, and the contact force sensor 33.

The contact force sensor 33 detects a contact force received by the hand 2 from another object. The contact force sensor 33 detects at least the force in the direction of the center axis Z between the fingers 22, and therefore, detects the contact force when the fingers 22 contact another object in the direction of the center axis Z. The haptic controller 68 determines that the fingers 22 contact another object if the contact force detected by the contact force sensor 33 is a predetermined first threshold or more. The first threshold is the value of a contact force from which it can be determined that the hand 2 contacts another object, and is a relatively small value.

The haptic controller 68 obtains, based on the detection result of the encoder 31, a deviation between the current angular position and command angular position of the corresponding servo motor 14 of the robot arm 11. The angular position deviation of the servo motor 14 corresponds to a contact force received by the robot arm 11 from another object. The haptic controller 68 determines that the robot arm 11 contacts another object if the angular position deviation is a predetermined second threshold or more. The second threshold is the value of a deviation equivalent to a contact force from which it can be determined that the robot arm 11 contacts another object.

The haptic controller 68 obtains, based on the detection result of the encoder 32, a deviation between the current angular position and command angular position of the servo motor 23 of the hand 2. The angular position deviation of the servo motor 23 corresponds to a contact force received by the fingers 22 from another object in the opening-closing direction X. The haptic controller 68 determines that the fingers 22 contact another object if the angular position deviation is greater than a predetermined third threshold. The third threshold is the value of a deviation equivalent to the force of the fingers 22 for gripping the workpiece W. For example, when the fingers 22 contact the workpiece W to grip the workpiece W, the fingers 22 cannot be closed any further, and the deviation of the servo motor 23 increases and exceeds the third threshold. In this case, the haptic controller 68 determines that the fingers 22 contact another object.

The haptic controller 68 recognizes, as different types of contact, the contact detected by each of the encoder 31, the encoder 32, and the contact force sensor 33. That is, the haptic controller 68 determines the type of contact of the robot 1 based on which one of the encoder 31, the encoder 32, or the contact force sensor 33 has detected the contact. For example, if each of the encoder 31 and the contact force sensor 33 detects the contact, the haptic controller 68 determines that two different types of contact occur.

If the contact of the robot 1 with another object occurs, the haptic controller 68 operates the haptic stimulator 8. The haptic controller 68 operates the haptic stimulator 8 for each of the different types of contact. Specifically, the haptic controller 68 changes the operation mode of the haptic stimulator 8 according to the number of types of contact occurred simultaneously. If one type of contact occurs, the haptic controller 68 outputs a command for generating the first vibration to the haptic stimulator 8. If two types of contact occur, the haptic controller 68 outputs a command for generating the second vibration to the haptic stimulator 8. If three types of contact occur, the haptic controller 68 outputs a command for generating the third vibration to the haptic stimulator 8. In any case, the haptic controller 68 determines the operation mode based only on the number of types of contact regardless of the type of contact, and outputs a corresponding command.

In addition, the haptic controller 68 determines the magnitude of contact force of the robot 1, and changes the operation mode of the haptic stimulator 8 according to the magnitude of contact force. Specifically, the haptic controller 68 monitors whether or not the contact of the robot 1 with another object occurs with the contact force whose degree requires forced stop of movement of the robot 1 (hereinafter referred to as “strong contact”). Here, the strong contact is contact with a contact force greater than the contact force used when it is determined that the contact occurs based on the detection result of each sensor. If the contact force detected by the contact force sensor 33 is a first upper limit, which is greater than the first threshold, or more, the haptic controller 68 determines that the strong contact of the fingers 22 occurs. If the angular position deviation of the servo motor 14 is a second upper limit, which is greater than the second threshold, or more, the haptic controller 68 determines that the strong contact of the robot arm 11 occurs. If the angular position deviation of the servo motor 23 is a third upper limit, which is greater than the third threshold, or more, the haptic controller 68 determines that the strong contact of the fingers 22 in the opening-closing direction X occurs. Each of the first upper limit, the second upper limit, and the third upper limit is a value equivalent to the contact force whose degree requires forced stop of movement of the robot 1.

If the strong contact of the robot 1 occurs, the haptic controller 68 outputs a command for generating the warning vibration to the haptic stimulator 8. The vibration mode of the warning vibration is different from those of the first vibration, the second vibration, and the third vibration.

### [Picking Job]

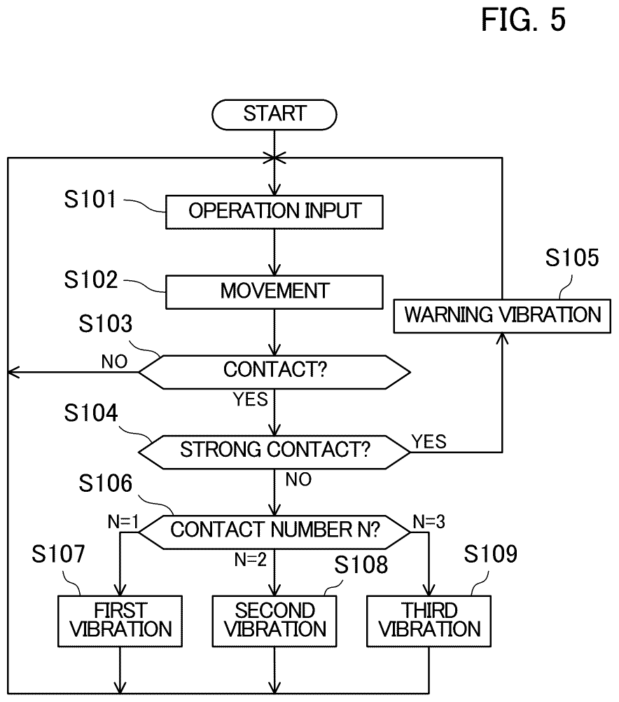

Operation of the remote control system 100 configured in the above-described manner will be described by taking the picking job as a specific example of the job performed by the robot 1. FIG. 5 is a flowchart of the remote control. The picking job is a job of the robot 1 picking the workpiece W from a container C from a predetermined start state and transporting the workpiece W to a tray T. The picking job includes a first movement step of moving the hand 2 to a picking position, a gripping step of causing the hand 2 to grip the workpiece W, a second movement step of moving the hand 2 gripping the workpiece W to a transport position, and a release step of causing the hand 2 to release the workpiece W.

In the remote control system 100, the image of the robot 1 captured by the imager 51 is displayed on the display 52. The user operates the operator 4 while viewing the image of the robot 1 displayed on the display 52. The displaying the image of the robot 1 on the display 52 is equivalent to presenting the image of the moving robot 1 to the user via the display 52.

First, in Step S101, the user makes input for the operation to the operator 4. When the user operates the operator 4, the operation information is input from the operator 4 to the processor 61. The input processor 64 of the processor 61 receives the operation information from the operator 4. Step S101 is equivalent to receiving the input from the user via the operator 4.

In Step S102, the processor 61 causes the robot 1 to perform movement according to the operation information. Specifically, the input processor 64 generates the command velocity according to the operation information from the operator 4. The command position generator 65 converts the command velocity into the position command. The command angle converter 66 converts the position command into the command angular position, and outputs the obtained command angular position to the movement controller 75. The movement controller 75 outputs the current for the command angular position to the corresponding servo motor 14 or servo motor 23. The movement controller 75 performs the feedback control on the applied current based on the detection signal of the encoder 31 or the encoder 32. In this manner, the robot 1 performs movement according to operation of the operator 4 by the user. Step S102 is equivalent to moving the robot 1 based on the input to the operator 4.

Next, in Step S103, the processor 61 determines whether or not the robot 1 contacts another object. The processor 61 determines, based on the detection results of the encoder 31, the encoder 32, and the contact force sensor 33, whether or not the robot 1 contacts another object. Specifically, if the contact force detected by the contact force sensor 33 is the first threshold or more, the angular position deviation obtained for the servo motor 14 based on the detection result of the encoder 31 is the second threshold or more, or a case where the angular position deviation obtained for the servo motor 23 based on the detection result of the encoder 32 is the third threshold or more, the haptic controller 68 determines that the contact occurs.

If no contact occurs, the processor 61 returns to Step S101, and repeats the processing from Step S101. The processing from Step S101 is repeated in a predetermined control cycle, and accordingly, the robot 1 continuously moves according to operation on the operator 4 by the user.

When the contact of the robot 1 with another object occurs during movement of the robot 1, the processor 61 proceeds to the processing of Step S104 from Step S103. In Step S104, the processor 61 determines whether or not the occurred contact is the strong contact. Specifically, if the contact force, the angular position deviation of the servo motor 14, or the angular position deviation of the servo motor 23, which is used for the determination of Step S103, is the corresponding upper limit or more, the haptic controller 68 determines that the strong contact occurs.

If the strong contact occurs, the haptic controller 68 outputs, in Step S105, the command for generating the warning vibration to the haptic stimulator 8. The haptic stimulator 8 generates the warning vibration. By the warning vibration of the haptic stimulator 8, the user can recognize that the robot 1 contacts another object with a great contact force. Thus, the user can stop movement of the robot 1, or can move the robot 1 such that the contact of the robot 1 is eliminated. Note that the processor 61 may forcibly stop the robot 1 in addition to the generation of the warning vibration.

On the other hand, if the contact is not the strong contact, the haptic controller 68 determines, in Step S106, the number N of types of contact occurred simultaneously (hereinafter referred to as a “contact number N”). If the contact number N is 1, the haptic controller 68 outputs, in Step S107, the command for generating the first vibration to the haptic stimulator 8. If the contact number N is 2, the haptic controller 68 outputs, in Step S108, the command for generating the second vibration to the haptic stimulator 8. If the contact number N is 3, the haptic controller 68 outputs, in Step S109, the command for generating the third vibration to the haptic stimulator 8. The haptic stimulator 8 generates the vibration according to the command. Steps S105, S107, S108, S109 are equivalent to operating the haptic stimulator 8 that applies the stimulus to the user's sense of touch if the robot 1 contacts another object.

In this manner, when the contact of the robot 1 with another object occurs during movement of the robot 1, the haptic stimulator 8 generates the vibration to notify the user of the occurrence of the contact. The user can recognize the occurrence of the contact by the vibration of the haptic stimulator 8. In addition, the user can determine, from the image of the robot 1 displayed on the display 52, what type of contact occurs. For example, the job may include a step involving contact upon completion. When the user is notified of the contact at timing at which it can be predicated based on the operation on the operator 4 and the image on the display 52 that the step is substantially completed, the user determines that the step is completed, and can proceed to a next step. Alternatively, when the user is notified of the contact by the haptic stimulator 8 at timing at which the contact cannot be predicted even based on the operation on the operator 4 and the image on the display 52, the user can recognize that unexpected contact occurs at a location which cannot be checked via the display 52 or the like. Further, if the vibration of the haptic stimulator 8 at this time is the warning vibration, the user can recognize that the unexpected contact involves a relatively-great contact force. Thus, the user can cause the robot 1 to perform avoidance movement.

More specifically, in the example of the picking job, the user first causes the robot 1 to perform the first movement step. Specifically, the user operates the operator 4 to set the operation to the first mode. The user operates the direction key 41a and the second input button 41c or the fourth input button 41e if needed while viewing the display 52, thereby moving the hand 2 to a gripping position. The gripping position is the position of the workpiece W in the container C. Steps S101, S102, S103 are repeated, and accordingly, the hand 2 gradually moves from the start position to the gripping position. Basically, the user determines the arrival of the hand 2 at the gripping position based on the image on the display 52. If the fingers 22 unexpectedly contact the bottom of the container C or the like in the first movement step, the contact force sensor 33 detects the contact force (Step S103). Since the contact number N at this time is 1, the haptic controller 68 causes the haptic stimulator 8 to generate the first vibration (Step S107). When sensing the first vibration of the haptic stimulator 8, the user can determine the contact of the fingers 22 with the bottom of the container C or the like from the contents of the operation on the operator 4 and the image of the robot 1 on the display 52. If the fingers 22 contact the bottom of the container C or the like, the hand 2 substantially reaches the gripping position, and therefore, the user causes the fingers 22 to eliminate the contact thereof and stops movement of the robot 1.

Depending on the image quality of the display 52 or the angle of view of the imager 51, the contact of the fingers 22 with the bottom of the container C may not be able to be checked from the image on the display 52. Even in this case, the user can recognize, from the image on the display 52, that the hand 2 approaches the container C, and can recognize, from the vibration of the haptic stimulator 8, that the contact of the robot 1 occurs. In this manner, the user can eliminate the accidental contact of the fingers 22, and can properly determine that the fingers 22 substantially reach the gripping position.

Upon completion of the first movement step, the user causes the robot 1 to perform the gripping step. The user operates the operator 4 to switch the operation from the first mode to the second mode. For example, the user causes the fingers 22 to perform the closing movement by keeping pressing the first input button 41b. Steps S101, S102, S103 are repeated, and accordingly, the fingers 22 approach the workpiece W. Eventually, when the fingers 22 contact the workpiece W and the contact force reaches a predetermined gripping force, the haptic controller 68 detects the contact of the fingers 22 based on the detection result of the encoder 32 (Step S103). By the contact of the fingers 22 with the workpiece W, the contact number N reaches 1. The haptic controller 68 causes the haptic stimulator 8 to generate the first vibration (Step S107). The user senses the vibration of the haptic stimulator 8, and therefore, can recognize that the contact of the fingers 22 with the workpiece W occurs. Since the user can determine the contact of the fingers 22 from the contents of the operation on the operator 4 and the image of the robot 1 on the display 52, the user determines that the gripping step is completed and stops movement of the fingers 22 when sensing the first vibration of the haptic stimulator 8. Thus, the contact at this time rarely reaches the strong contact.

Depending on the image quality of the display 52 or the angle of view of the imager 51, the gripping of the workpiece W with the fingers 22 may not be able to be checked from the image on the display 52. Even in this case, the user can recognize, from the image on the display 52, that the fingers 22 approach the workpiece W, and can recognize, from the vibration of the haptic stimulator 8, that the contact of the robot 1 occurs. In this manner, the user can properly determine completion of the gripping step from the vibration of the haptic stimulator 8.

Upon completion of the gripping step, the user causes the robot 1 to perform the second movement step. The user operates the operator 4 to switch the operation from the second mode to the first mode. The user operates the direction key 41a and the second input button 41c or the fourth input button 41e if needed while viewing the display 52, thereby moving the hand 2 to the transport position. Steps S101, S102, S103 are repeated, and accordingly, the hand 2 gradually moves from the gripping position to the transport position. While the hand 2 is holding the workpiece W, the detection of the contact of the fingers 22 based on the encoder 32 is continued, and therefore, the haptic stimulator 8 keeps generating the first vibration.

When the hand 2 reaches the transport position, the workpiece W is placed on the bottom of the tray T. Accordingly, the contact force sensor 33 detects the contact force received by the fingers 22 from the bottom of the tray T via the workpiece W (Step S103). The contact number N increases from 1 to 2, and the haptic controller 68 causes the haptic stimulator 8 to generate the second vibration (Step S108). Since the user can determine the contact of the workpiece W from the contents of the operation on the operator 4 and the image of the robot 1 on the display 52, the user determines that the second movement step is completed and stops movement of the robot 1 when sensing the second vibration of the haptic stimulator 8. Thus, the contact at this time rarely reaches the strong contact.

Depending on the image quality of the display 52 or the angle of view of the imager 51, the contact of the workpiece W with the bottom of the tray T may not be able to be checked from the image on the display 52. Even in this case, the user can recognize, from the image on the display 52, that the workpiece W approaches the bottom of the tray T, and can recognize, from the vibration of the haptic stimulator 8, that the contact of the robot 1 occurs. In this manner, the user can properly determine completion of the second movement step from the vibration of the haptic stimulator 8.

Upon completion of the second movement step, the user causes the robot 1 to perform the release step. The user operates the operator 4 to switch the operation from the first mode to the second mode. For example, the user causes the fingers 22 to perform the opening movement by keeping pressing the third input button 41d. Steps S101, S102, S103 are repeated, and accordingly, the fingers 22 are separated from the workpiece W. When the fingers 22 are separated from the workpiece W, the contact force based on the encoder 32 reaches zero. In addition, the contact force acting on the fingers 22 from the bottom of the tray T via the workpiece W also reaches zero. The haptic controller 68 stops the vibration of the haptic stimulator 8. Since the vibration of the haptic stimulator 8 is stopped, the user can recognize that the contact of the fingers 22 is eliminated. Since the user can determine the elimination of the contact of the fingers 22 from the contents of the operation on the operator 4 and the image of the robot 1 on the display 52, the user determines that the release step is completed and stops movement of the fingers 22 when sensing the first vibration of the haptic stimulator 8.

Depending on the image quality of the display 52 or the angle of view of the imager 51, the release of the gripped workpiece W may not be able to be checked from the image on the display 52 unless the fingers 22 are opened widely. Even in this case, the user can recognize, by reduction or elimination of the vibration of the haptic stimulator 8, that the contact of the robot 1 with another object is eliminated. In this manner, the user can properly determine completion of the release step by the reduction or elimination of the vibration of the haptic stimulator 8.

Upon completion of the release step, the picking job is completed. Note that the picking job may be completed with return of the robot 1 to the start state after the release step.

In addition, if the unexpected contact of the robot 1 occurs during the picking job, the haptic stimulator 8 notifies, by generating the warning vibration, the user of the occurrence of the contact of the robot 1 and prompts the user to select the avoidance movement. That is, if the unexpected contact occurs, the user does not promptly stop movement of the robot 1, and therefore, a relatively-great contact force may act on the robot 1. Particularly, if a portion of the robot 1, which is not displayed on the display 52, contacts another object, the user cannot recognize the occurrence of the contact via the display 52, and for this reason, a relatively-great contact force is easily generated. When the contact with the relatively-great contact force is detected, the haptic controller 68 determines, in Step S104, that the strong contact occurs, and causes, in Step S105, the haptic stimulator 8 to generate the warning vibration. In this manner, the user can recognize the occurrence of the contact of the robot 1, which cannot be recognized via the display 52, and can promptly eliminate the contact of the robot 1.

The remote control system 100 notifies the user of the occurrence of the contact of the robot 1 through the user's sense of touch by the haptic stimulator 8. The user determines the cause for the contact based on the operation on the operator 4, the image of the robot 1 on the display 52, the vibration mode, and the like. If the contact is related to completion of the step, the user proceeds to the next step. If the contact is unexpected, the user stops movement of the robot 1, or moves the robot 1 such that the contact is eliminated. That is, the user can properly determine the status of the robot 1.

Note that as long as the above-described picking job is properly performed, the contact number N does not reach 3. However, a situation where the contact number N reaches 3 may occur depending on the job of the robot 1. In this case, the haptic stimulator 8 generates the third vibration.

In the above-described description, the operator 4 makes input for continuous movement of the robot 1, i.e., continuously inputs a movement trajectory. That is, the robot 1 moves while the input from the operator 4 is continued, and stops when the input from the operator 4 is stopped. However, the operation input from the operator 4 is not limited to above. For example, a command may be input from the operator 4, and the controller 6 may autonomously control the robot 1 and cause the robot 1 to perform movement according to the command.

For example, in the picking job, the operator 4 receives, from the user, commands corresponding to steps. The commands include a first movement step execution command, a gripping step execution command, a second movement step execution command, and a release step execution command. For example, the step execution commands may be each assigned to the first input button 41b, second input button 41c, third input button 41d, and fourth input button 41e of the operator 4. Alternatively, the step execution commands may be displayed as options on the display 52, one command may be selected via the direction key 41a, and a desired command may be input from the operator 4 to the controller 6 by confirmation of the command via the first input button 41b.

The controller 6 causes the robot 1 to perform a step corresponding to a command input to the operator 4. Specifically, the input processor 64 determines the step to be performed based on the operation information from the operator 4. The command position generator 65 generates the trajectory of the robot 1 for performing movement corresponding to the determined step. The trajectory of the robot 1 may be generated based on preset teaching information, or the trajectory generated in this manner in advance may be corrected based on the image captured by the imager 51. The command position generator 65 sequentially outputs, to the command angle converter 66, the command position for the generated trajectory of the robot 1. The contents of the control by the command angle converter 66 and the movement controller 75 are similar to those in the case of the above-described continuous movement input.

The picking job by the command input will be specifically described. First, the user inputs the first movement step execution command via the operator 4. The processor 61 moves the robot 1 such that the hand 2 moves from the start position to the gripping position. After inputting the first movement step execution command, the user stands by until completion of the first movement step. When the hand 2 reaches the gripping position, the fingers 22 contact the bottom of the container C. The contact force sensor 33 detects the contact force, and the haptic stimulator 8 generates the first vibration. The user can properly recognize completion of the first movement step by the vibration of the haptic stimulator 8 even if it is difficult to determine completion of the first movement step only from the image of the robot 1 on the display 52.

When sensing completion of the first movement step, the user inputs the gripping step execution command via the operator 4. The processor 61 causes the fingers 22 to perform the closing movement. After inputting the gripping step execution command, the user stands by until completion of the gripping step. When the fingers 22 contact the workpiece W and grip the workpiece W with the predetermined gripping force, the vibration of the haptic stimulator 8 switches from the first vibration to the second vibration. It is difficult for the user to determine, only from the image of the robot 1 on the display 52, whether or not the fingers 22 grip the workpiece W with the predetermined gripping force. The user can properly recognize, by the vibration of the haptic stimulator 8, that the gripping of the workpiece W with the fingers 22 is completed.

When sensing completion of the gripping step, the user inputs the second movement step execution command via the operator 4. The processor 61 moves the robot 1 such that the hand 2 moves from the container C to the tray T. After inputting the second movement step execution command, the user stands by until completion of the second movement step. In the second movement step, the fingers 22 are separated from the bottom of the container C, and therefore, the contact number N decreases from 2 to 1 and the vibration of the haptic stimulator 8 switches from the second vibration to the first vibration. When the hand 2 reaches the transport position in the tray T, the fingers 22 contact the bottom of the tray T. Since the contact number N increases from 1 to 2, the vibration of the haptic stimulator 8 switches from the first vibration to the second vibration. Even if it is difficult for the user to determine completion of the second movement step only from the image of the robot 1 on the display 52, the user can properly recognize completion of the second movement step by the vibration of the haptic stimulator 8.

When sensing completion of the second movement step, the user inputs the release step execution command via the operator 4. The processor 61 causes the fingers 22 to perform the opening movement. After inputting the release step execution command, the user stands by until completion of the release step. When the fingers 22 are separated from the workpiece W, the vibration of the haptic stimulator 8 switches from the second vibration to the first vibration. It is difficult for the user to determine the separation of the fingers 22 from the workpiece W only from the image of the robot 1 on the display 52. The user can properly recognize, by the vibration of the haptic stimulator 8, that the release of the gripped workpiece W from the fingers 22 is completed.

In a case of repeating the picking job, the user inputs the first movement step execution command again via the operator 4. On the other hand, when the user inputs an end command via the operator 4, the picking job ends.

Even if the picking job is performed based on the command input, the user can recognize completion of each step by the vibration of the haptic stimulator 8. Thus, the user can smoothly proceed to the next step without unnecessarily waiting for completion of the step.

As described above, in the first aspect of the technique of the present disclosure, the remote control system 100 includes the robot 1, the operator 4 that receives the input from the user, the display 52 that presents the image of the robot 1 to the user, the haptic stimulator 8 that applies the stimulus to the user's sense of touch, and the controller 6 that controls the robot 1 based on the input to the operator 4, and the controller 6 operates the haptic stimulator 8 if the robot 1 contacts another object.

According to this configuration, when the robot 1 is remotely controlled via the operator 4, the user can properly recognize, by operation of the haptic stimulator 8, the contact between the robot 1 and another object, which is difficult to be determined only from the image of the robot 1 on the display 52. Moreover, it is not necessary to improve the image quality of the display 52 or the like in order to enhance the accuracy of determination on the contact of the robot 1, and therefore, a delay in the image displayed on the display is reduced. In this manner, the user can properly determine the status of the robot 1.

In the second aspect of the technique of the present disclosure, in the remote control system 100 according to the first aspect, the controller 6 causes the robot 1 to perform the job including the steps based on the input to the operator 4, and operates the haptic stimulator 8 if the robot 1 contacts another object upon completion of at least one of the steps.

According to this configuration, the user can properly recognize completion of the step. That is, even in a case where it is difficult to properly determine the contact of the robot 1 only from the image of the robot 1 on the display 52, the haptic stimulator 8 notifies the user of the occurrence of the contact of the robot 1. The user takes both the operation on the operator 4 by the user oneself and the image on the display 52 into consideration, and therefore, can properly determine that the contact is contact of the robot 1 upon completion of the step.

In the third aspect of the technique of the present disclosure, in the remote control system 100 according to the second aspect, the operator 4 receives the commands corresponding to the steps, and the controller 6 causes the robot to perform the step corresponding to the command input to the operator 4.

According to this configuration, the command is input via the operator 4, and the controller 6 causes the robot 1 to perform the step corresponding to the input command. In the step which involves the contact of the robot 1 upon completion among the steps, by operation of the haptic stimulator 8, the user is notified of the contact of the robot 1 upon completion of the step. That is, the user inputs the command via the operator 4 and stands by until completion of the step so that the user can properly recognize completion of the step by operation of the haptic stimulator 8. As a result, the user can smoothly proceed to the next step without unnecessarily waiting for completion of the step.

In the fourth aspect of the technique of the present disclosure, in the remote control system 100 according to the third aspect, the controller 6 changes the operation mode of the haptic stimulator 8 according to the number of types of contact occurred simultaneously.

According to this configuration, the controller 6 can notify, by the vibration mode of the haptic stimulator 8, the user of the number of types of contact occurred simultaneously. Even in a case where the contact has already occurred and the haptic stimulator 8 is in operation, the user can recognize that a new type of contact occurs or part of the contact already occurred is eliminated.

In the fifth aspect of the technique of the present disclosure, in the remote control system 100 according to any one of the first to third aspects, the controller 6 determines the type of contact of the robot 1, and operates the haptic stimulator 8 for each of the different types of contact.

According to this configuration, the controller 6 can determine each type of contact even if the contact of multiple types occurs simultaneously.

In the sixth aspect of the technique of the present disclosure, in the remote control system 100 according to any one of the first to fifth aspects, the controller 6 determines the magnitude of contact force of the robot, and changes the operation mode of the haptic stimulator according to the magnitude of contact force.

According to this configuration, the operation mode of the haptic stimulator 8 is changed according to the magnitude of contact force. The user can also recognize the magnitude of contact force in addition to the occurrence of the contact.

In the seventh aspect of the technique of the present disclosure, the remote control system 100 according to any one of the first to sixth aspects further includes the sensor 3 that detects the force acting on the robot 1, and the controller 6 determines the contact of the robot 1 with another object based on the detection result of the sensor 3.

According to this configuration, the controller 6 determines the contact of the robot 1 based on the detection result of the sensor 3.

In the eighth aspect of the technique of the present disclosure, in the remote control system 100 according to the seventh aspect, the robot 1 includes the robot arm 11 and the hand 2 having the fingers 22 that perform the opening-closing movement and coupled to the robot arm 11, the controller 6 causes the robot 1 to perform the job of picking the workpiece W, and the sensor 3 includes the contact force sensor 33 (first sensor) that detects the force acting on the fingers 22 from the surface on which the workpiece W is placed, and the encoder 32 (second sensor) that detects the force acting on the fingers 22 from the workpiece W in the opening-closing direction of the fingers 22.

According to this configuration, during the picking job, the fingers 22 of the hand 2 contact the surface on which the workpiece W is placed, or grip the workpiece W. That is, in the picking job, the contact of the fingers 22 occurs multiple times, and occurs at the timing of completion of some steps. That is, in the picking job, the haptic stimulator 8 notifies the user of the contact of the fingers 22, and therefore, can substantially notify the user of completion of the step.

From a different point of view, in the ninth aspect of the technique of the present disclosure, the remote control system 100 includes the robot 1, the operator 4 that receives the input from the user, the display 52 that presents the image of the robot 1 to the user, the haptic stimulator 8 that applies the stimulus to the user's sense of touch, and the controller 6 that causes the robot 1 to perform the job including the steps based on the input to the operator 4, and the controller 6 operates the haptic stimulator 8 upon completion of at least one of the steps.

According to this configuration, when the robot 1 is remotely controlled via the operator 4, the user can properly recognize, by operation of the haptic stimulator 8, completion of the step which is difficult to be determined only from the image of the robot 1 on the display 52. Moreover, it is not necessary to improve the image quality of the display 52 or the like in order to enhance the accuracy of determination on completion of the step performed by the robot 1, and therefore, the delay in the image displayed on the display is reduced. In this manner, the user can properly determine the status of the robot 1.

In this case, the controller 6 operates the haptic stimulator 8 based on whether or not the step is completed. Then, the controller 6 determines completion of the step based on whether or not the contact of the robot 1 occurs. In the above-described picking job, the contact status of the robot 1 changes upon completion of the step. Thus, operation of the haptic stimulator 8 based on the contact of the robot 1 is equal to operation of the haptic stimulator 8 based on completion of the step. However, there is a job in which the contact status of the robot 1 does not always change upon completion of the step. In this case, the controller 6 may operate the haptic stimulator 8 if the step is completed although no contact of the robot 1 occurs.

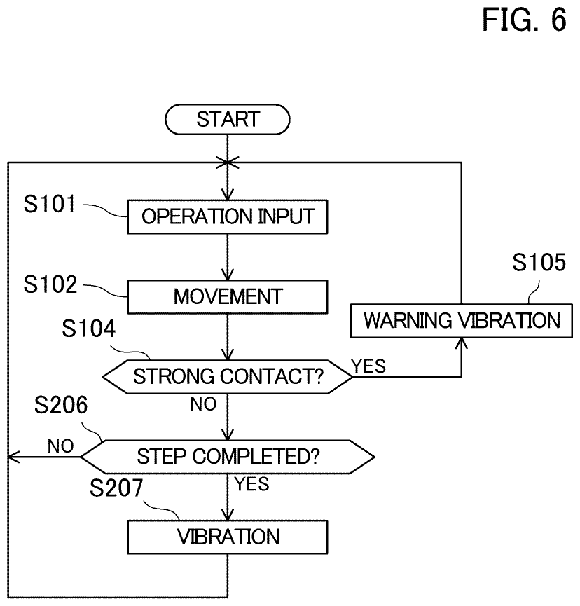

A flowchart of the remote control in this case is shown in FIG. 6. In the flowchart of FIG. 6, Steps S103, S106, S107, S108, S109 are omitted from the flowchart of FIG. 5, and instead, Steps S206, S207 are added. Specifically, the processor 61 does not determine whether or not the robot 1 contacts another object during operation of the robot 1, and in Step S104, determines whether or not the strong contact occurs. The processing of Step S104 is the same as that of the flowchart of FIG. 5, and if the strong contact occurs, the haptic controller 68 outputs, in Step S105, the command for generating the warning vibration to the haptic stimulator 8. Instead of monitoring the contact of the robot 1, the processor 61 determines whether or not the step is completed in Step S206. As long as no strong contact occurs and the step is not completed, the processor 61 moves the robot 1 based on the input to the operator 4 by repeating Steps S101, S102. The processor 61 can determine completion of the step by various methods. As one technique, the processor 61 determines completion of the step based on whether or not the contact of the robot 1 occurs. The steps include one involving the contact of the robot 1 upon completion. The processor 61 can determine completion of such a step based on the contact of the robot 1. For the step whose completion cannot be determined based on the contact of the robot 1, the processor 61 may determine completion based on a signal from the outside, such as the input from the user via the operator 4. Then, if the step is completed, the processor 61 causes the haptic stimulator 8 to generate the vibration in Step S207. At this time, the processor 61 may change the vibration mode of the haptic stimulator 8 according to the contact number N, as described above.

In the tenth aspect of the technique of the present disclosure, the robot remote control method for controlling the robot 1 via the operator 4 includes the receiving the input from the user via the operator 4, the moving the robot 1 based on the input to the operator 4, the presenting the image of the moving robot 1 to the user via the display 52, and the operating the haptic stimulator 8 that applies the stimulus to the user's sense of touch if the robot 1 contacts another object.

According to this configuration, when the robot 1 is remotely controlled via the operator 4, the user can properly recognize, by operation of the haptic stimulator 8, the contact between the robot 1 and another object, which is difficult to be determined only from the image of the robot 1 on the display 52. Moreover, it is not necessary to improve the image quality of the display 52 or the like in order to enhance the accuracy of determination on the contact of the robot 1, and therefore, the delay in the image displayed on the display is reduced. In this manner, the user can properly determine the status of the robot 1.

In the eleventh aspect of the technique of the present disclosure, the remote control program 62a is the program causing the processor 61 (computer) to implement the function of controlling the remote control system 100 including the robot 1, the operator 4 that receives the input from the user, and the haptic stimulator 8 that applies the stimulus to the user's sense of touch, and the program further causes the processor 61 to implement the function of receiving the input from the user via the operator 4, the function of moving the robot 1 based on the input to the operator 4, and the function of operating the haptic stimulator 8 that applies the stimulus to the user's sense of touch if the robot 1 contacts another object.

According to this configuration, when the robot 1 is remotely controlled via the operator 4, the user can properly recognize, by operation of the haptic stimulator 8, the contact between the robot 1 and another object. Thus, the user can properly determine the status of the robot 1.

### OTHER EMBODIMENTS

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

The above-described configuration of the remote control system 100 is merely one example, and the present disclosure is not limited thereto. For example, the job performed by the robot 1 is not limited to the picking job. The job performed by the robot 1 may be a processing job. Moreover, the end effector of the robot arm 11 is not limited to the hand 2. The end effector may be changed according to the job performed by the robot 1.

The robot 1 is not limited to the industrial robot. For example, the robot 1 may be a medical robot.

The sensor 3 that detects the force acting on the robot 1 is not limited to the encoder 31, the encoder 32, and the contact force sensor 33. A force sensor other than these sensors may be further disposed. Moreover, the sensor 3 is only required to include at least one of the encoder 31, the encoder 32, or the contact force sensor 33, and does not necessarily include some of the encoder 31, the encoder 32, and the contact force sensor 33. Instead of the encoder 31 or the encoder 32, a current sensor that detects the current of the servo motor 14, a torque sensor that detects the torque of the servo motor 14, a current sensor that detects the current of the servo motor 23, a torque sensor that detects the torque of the servo motor 23, or the like may be disposed. The force acting on the robot 1 may be detected based on a deviation between the current and target values of the current or the torque.

The imager 51 is not limited to one attached to the robot arm 11. The imager 51 may be located in a fixed manner at a position at which the image of the robot 1 can be captured.

The above-described configuration of the operator 4 is one example. The operator 4 may have a handle such as a joystick. The operator 4 may have an input device such as a touch panel. The input via the operator 4 may include not only the movement direction of the robot 1, but also the speed of movement of the robot 1. For example, in the case of the operator 4 having the handle such as the joystick, the movement speed may be input by tilting the joystick.

The haptic stimulator 8 is not limited to the above-described configuration. As long as the haptic stimulator 8 can apply the stimulus to the user's sense of touch, the haptic stimulator 8 may be attached to the user in an arbitrary form. The haptic stimulator 8 may be built in the operator 4. Moreover, the vibration actuator of the haptic stimulator 8 is not limited to the voice coil motor 81. The vibration actuator of the haptic stimulator 8 may be of an eccentric rotating mass type or a piezo type.

The haptic stimulator 8 may have vibration actuators. The combination of the vibration actuators may be changed according to various types of contact of the robot 1, and in this manner, the type of contact of the robot 1 may be notified to the user. For example, the type of contact of the robot 1 may be notified to the user in a distinguishable manner by a technique using haptic illusion.

The vibration generated by the haptic stimulator 8 is not limited to the first vibration, the second vibration, the third vibration, and the warning vibration. The possible contact of the robot 1 may change according to the configuration of the robot 1, the job of the robot 1, and the like. The vibration of the haptic stimulator 8 may be set for the contact of the robot 1 conceivable according to the configuration of the robot 1, the job of the robot 1, and the like. For example, the vibration generated by the haptic stimulator 8 may be changed in two levels or four or more levels.

The block diagram described above is one example, and blocks may be implemented as one block, one block may be divided into blocks, or some functions may be transferred to another block.

The technique of the present disclosure may be a non-transitory computer-readable storage medium storing the remote control program 62a. Moreover, the remote control program 62a may be distributed via a transmission medium such as the Internet.

The flowchart is merely one example. Changes, replacements, additions, omissions, etc. may be made to the steps of the flowchart as necessary. Moreover, the order of steps in the flowchart may be changed, or the processing performed in series may be performed in parallel.

The functions implemented by the components described in the present specification may be implemented on a circuitry or a processing circuitry including a versatile processor, an application specific processor, an integrated circuit, an application specific integrated circuit (ASIC), a central processing unit (CPU), a conventional circuit, and/or a combination thereof and programmed to implement the above-described functions. A processor includes a transistor and other circuits, and is taken as a circuitry or a processing circuitry. The processor may be a programmed processor that executes a program stored in a memory.

In the present specification, a circuitry, a unit, or means is hardware programmed to implement the described functions or configured to execute the described functions. The hardware is any type of hardware disclosed in the present embodiment or known hardware programmed to implement the described functions or configured to execute the described functions.

In a case where the hardware is a processor of a circuitry type, a circuitry, means, or a unit is a combination of hardware and software used for configuring hardware and/or a processor.

1. A remote control system comprising:
a robot;
an operator that receives input from a user;
a display that presents an image of the robot to the user;
a haptic stimulator that applies a stimulus to a user's sense of touch; and
a controller that controls the robot based on the input to the operator,
wherein the controller operates the haptic stimulator if the robot contacts another object.

2. The remote control system of claim 1, wherein
the controller
causes the robot to perform a job including steps based on the input to the operator, and
operates the haptic stimulator if the robot contacts another object upon completion of at least one of the steps.

3. The remote control system of claim 2, wherein
the operator receives commands corresponding to the steps, and
the controller causes the robot to perform a step corresponding to a command input to the operator.

4. The remote control system of claim 3, wherein
the controller changes an operation mode of the haptic stimulator according to the number of types of contact occurred simultaneously.

5. The remote control system of claim 1, wherein
the controller determines a type of contact of the robot, and operates the haptic stimulator for each of different types of contact.

6. The remote control system of claim 1, wherein
the controller determines a magnitude of a contact force of the robot, and changes an operation mode of the haptic stimulator according to the magnitude of the contact force.

7. The remote control system of claim 1, further comprising:
a sensor that detects a force acting on the robot,
wherein the controller determines contact of the robot with another object based on a detection result of the sensor.

8. The remote control system of claim 7, wherein
the robot includes a robot arm and a hand having a finger that performs opening-closing movement and coupled to the robot arm,
the controller causes the robot to perform a workpiece picking job, and
the sensor includes a first sensor that detects a force acting on the finger from a surface on which a workpiece is placed, and a second sensor that detects a force acting on the finger from the workpiece in a finger opening-closing direction.

9. A remote control system comprising:
a robot;
an operator that receives input from a user;
a display that presents an image of the robot to the user;
a haptic stimulator that applies a stimulus to a user's sense of touch; and
a controller that causes the robot to perform a job including steps based on the input to the operator,
wherein the controller operates the haptic stimulator upon completion of at least one of the steps.

10. A robot remote control method for controlling a robot via an operator, comprising:
receiving input from a user via the operator;
moving the robot based on the input to the operator;
presenting an image of the moving robot to the user via a display; and
operating a haptic stimulator that applies a stimulus to a user's sense of touch if the robot contacts another object.

11. A non-transitory storage medium storing a remote control program causing a computer to implement a function of controlling a remote control system including a robot,
an operator that receives input from a user, and
a haptic stimulator that applies a stimulus to a user's sense of touch,
the remote control program further causing the computer to implement
a function of receiving the input from the user via the operator,
a function of moving the robot based on the input to the operator, and
a function of operating a haptic stimulator that applies a stimulus to a user's sense of touch if the robot contacts another object.
